(19) United States
(12) Patent Application Publication
(10) Pub. No.: US 2008/0229853 A1
(43) Pub. Date: Sep. 25, 2008

(54) Twisted Belt Transmission

(75) Inventor: Jean-Marc Baggio, Amneville (FR)

Correspondence Address: CANTOR COLBURN, LLP, 20 Church Street, 22nd Floor, Hartford, CT, 06103, US

(73) Assignee: PH.B INNOVATIONS SARL, STRASBOURG (FR)

(21) Appl. No.: 12/064,913

(22) PCT Filed: Aug. 25, 2006
(86) PCT No.: PCT/EP2006/065701

§ 371 Date: Feb. 26, 2008

(30) Foreign Application Priority Data
Aug. 26, 2005 (FR) 05 08771

(51) Int. Cl. F16H 19/00

(52) U.S. Cl. 74/319

(57) ABSTRACT

The invention relates to a transmission mechanism with step-down reduction, in which an open belt (2) twists around a driving pulley (1) while being unwound from a driven pulley (2).

### TECHNICAL FIELD OF THE INVENTION

The present invention relates to the field of mechanical transmissions with variable transmission ratio.

### BRIEF DESCRIPTION OF RELATED ART

Gear transmissions in which the radius can vary and the inter-axis distance is fixed find applications in the field of starting aids like in French Patent Application No. 0309582 of Aug. 4, 2003, published on Feb. 11, 2005, in a coaxial set up, or in French Patent Application No. 0406393 dated Jun. 14, 2004, which has not yet been published, in a set up in which the axes are parallel. These are systems that do not operate continuously but operate during a phase in which a variation in velocity ratio is desired. In general, during these phases, the driving shaft remains driving and there are no problems with reversing the transmission as there are for example in the case of engine brakes. To manufacture these gear sets it is necessary to adhere to mated pitch curves in order to keep the inter-axis distance at a common value for the tangent. It becomes difficult to specify the toothing when the variations in radius are great and slippage at the contact faces of the toothing detracts from the efficiency of the whole. In addition, rotations of these gear sets are limited to one revolution because they exhibit discontinuities if the radius varies in just one direction, unless provision is made for helical gearwheels like in French Patent Application No. 0406393, but then it becomes necessary to manage the longitudinal movement of the gearwheels and cope with other problems associated with the toothing. In general, these gearwheels have external tooth sets and rotate in opposite directions. One problem that has been resolved only in part is the possibility of having gearwheels with wide variations in radius, which can operate over more than one revolution, with a choice in the direction of relative rotation, an inter-axis distance that can be altered to suit the application, the possibility of non-parallel shafts, which are easy to manufacture, operate without translational movement due to the helixes, and have good efficiency.

There therefore remains a need for a simple system that combines these options in instances in which the driving shaft always remains driving and the system can be reset by rotating it in the opposite direction following uncoupling.

### BRIEF SUMMARY OF THE INVENTION

The invention provides a transmission system comprising a support structure and two pulleys, which pulleys are connected via a flexible element which may be a belt, a chain or any element known per se. This flexible element is wound onto the driving pulley while it is being unwound from the driven pulley and, through its thickness, gives the winding present on each pulley a spiral-wound pitch curve which increases the apparent radius of the driving pulley and decreases that of the driven pulley, thus reducing the reduction ratio and therefore being suitable for starting aids.

This flexible element adopts the position of a tangent to the pitch curves formed by the turns in situ, which means that these curves no longer have to remain tangential to one another as they did in the case of a gear set. There is therefore no longer any obligation to have mated curves or to adhere to a given inter-axis distance. It also becomes possible to change the direction of rotation by changing the direction of the windings. The pulleys may lie in the same plane with their axes parallel, but with a flexible element that will tolerate being twisted, it is possible to have axes that are non-parallel. In order to compensate for the variations in radius of the windings, guides position the flexible element in such a way that the strands tangential to the windings remain in the plane of the pulleys. It is possible to have an angle of up to 90° between the planes of the pulleys, just as a helical gear set of intersecting axes might achieve. In the case of coplanar pulleys, there is no need to have any guide and the flexible element follows the common tangent external to the windings in order to have the pulleys rotating in the same direction, or the internal common tangent with the pulleys rotating in opposite directions.

It will be noted than when the flexible element is wound onto itself on the driving pulley, its thickness gives the winding of the flexible element a spiral shape, which is a planar shape unlike a helix. In some instances it may be possible to obtain a winding of the flexible element onto at least part of the driving pulley in a spiral-shaped pitch curve by giving the surface portion (hub) of the driving pulley onto which the flexible element is wound the shape of a portion of a spiral.

In one particular embodiment of the invention, the thickness of the flexible element is constant and the hub of the pulleys is not cylindrical and exhibits an offset equal to this thickness in order to ensure the continuity of the pitch curve of the winding and of the pitch curve of the first turn. The flexible element is fixed to the hub, at the location of the offset, by any system known per se, by adhesive bonding or using screws, for example. The pitch curve of the windings on each pulley is the continuation of the curve of the hub. The choice of hub dimensions, thickness and working length of the flexible element set the variations in velocity ratio governing the rotation of the pulleys.

One example applied to a bicycle may be achieved with a belt 2.5 mm thick leaving a pulley mounted on the rear wheel and the diameter of which decreases from 90 to 50 mm in approximately 8 revolutions and which is wound onto a pulley mounted on the crank set and the diameter of which increases from 185 to 200 mm in approximately 3 revolutions. The equivalent in terms of sprocket and chain wheel would be a start using a bracket of 52/26, namely a step-up ratio of 2 and a finishing bracket of 52/13, namely a step-up ratio of 4, over a distance of about 20 m.

In one particular embodiment of the invention, at least two identical flexible elements are used. The objective is to spread the load and to balance the mechanism. There are two conceivable setups, a first one with a single driving pulley onto which the flexible elements originating from at least two driven pulleys are simultaneously wound. This is a transmission with one input shaft and at least two output shafts. Conversely, a second setup would have at least two driving pulleys winding at least two flexible elements originating from the same driven pulley. This transmission would then have at least two input shafts for just one output shaft. In both instances, it would be sensible to have the multiple pulleys evenly distributed about the single pulley and for the ends of the flexible element also to be fixed in a way that was evenly distributed on the hub of the single pulley.

In one particular embodiment of the invention, the guide system is designed with a turn element so that the pulleys can be mounted on one and the same shaft. This may be achieved using a first and a fourth guide which ensure that the tangential strands remain in the plane of the pulleys, and two other intermediate guides each twisting the flexible element through 90° with a separation corresponding to that of the pulleys, it being possible for these two guides to be a single 180° turn element sized in respect of this separation. It is also possible to use just one guide in total, this guide both twisting the two tangential strands and affording the separation if the variations in radius of the windings do not give rise to a misalignment of the tangential strands that will disrupt operation. This guide may be optimized by mounting it on a pivot so as to allow the flexible element to adopt the most suitable position.

In one particular embodiment of the invention, the pulleys are mounted on one and the same shaft and are connected by at least two identical flexible elements guided by their own guide systems which guide systems are again identical. The objective of this is to spread the loads and ensure balance. It is sensible for the guide systems and the ends of the flexible elements to be positioned about the single shaft in a way that is also evenly distributed.

In one particular embodiment of the invention, the pulleys are coaxial and coplanar, something which can be achieved only if the sum of their subtended angles and their relative travel is less than 360°. They therefore have the form of a sector of the spiral and the flexible element is perfectly guided with just one guide positioned in the common plane. Because the pulleys do not make one complete revolution, the variation in radius is obtained through the geometry of the hubs or through the variations in the thickness of the flexible element. Because the flexible element does not form a complete turn, it needs to be anchored at the start and end of the pulleys firmly enough because it will benefit less from the winding effect; by contrast, it will be able to adopt a path that is not tangential to the pulleys at the start and the end of the movement. This special feature can be exploited using pulleys that are reduced to a simple spoke to the end of which the flexible element, free to rotate, is attached. The lever arm becomes the distance between the axis and the straight line collinear with the strand of the flexible element and varies as the spoke rotates. For load-spreading and balancing reasons it is possible to have at least two of these mechanisms in the common plane.

In one particular embodiment of the invention, the pulleys rotate in the same direction on one and the same shaft in order to obtain a coaxial variable-speed drive. By allowing the support structure to rotate about the common axis only in the same direction as the pulleys, it is possible to produce a starting aid mechanism in the same spirit as the one in French patent Application No. 0309582 with a decreasing reduction when the support structure is prevented from rotating in the opposite direction and an automatic direct drive when the support structure rotates at the same speed and in the same direction as the pulleys when the windings have the same external radius or the same lever arm.

In one particular embodiment of the invention, a mechanism can rewind the flexible element onto the driven pulley. This is because use of a flexible element means that the driving pulley winds and the driven one unwinds and it therefore becomes necessary to stop at the end of the cycle, if not before. Depending on the application, this may be done by actually stopping the transmission system or by disengaging or uncoupling it in the case of a starting aid with continuous operation that takes over after the starting phase. In order to be able to perform a further operation, the transmission system has therefore to be rewound by rotating what was the driven pulley in the opposite direction. This can be done by an elastic system connected to this pulley which will have been stressed during normal operation, such as a spiral coiled spring, or by winding a cable that tensions a spring or raises a weight. It is also possible to provide an independent mechanism for performing this rotation.

In one particular embodiment of the invention, the pulleys have a cylindrical hub and the corresponding end of the flexible element which is fixed to this hub has a thickness that continuously tapers down to zero. The length of this part may ideally be at least equal to the circumference of the hub. This allows the spiral-form pitch curve to be started without any apparent discontinuity in the radius and it is sensible to keep more than one turn in place in order to enhance, through the winding effect, the attachment of the end of the flexible element to the hub, which attachment is achieved by any system known per se, for example by adhesive bonding or using screws.

In one particular embodiment of the invention, the thickness of a working part of the flexible element varies in order to allow the variation in the apparent radius of the pitch curve to be modified. An increase in the thickness amplifies the customary spiral effect, the radius increasing on the driving pulley and decreasing on the driven pulley, whereas a reduction in the thickness reduces this effect and being able to cancel out this effect, keeping the radius constant, or even to reverse it.

In one particular embodiment of the invention, the outside diameter of at least one of the windings or a mark on the flexible element is used to control said system that has to be stopped at the end of the cycle if not before. This can be done in a number of ways either by measuring the outside diameter of one of the windings or using a mechanical, optical, magnetic or some other mark positioned on the flexible element. A simple mechanical embodiment with a roller rolling along the outside of the driving pulley would also make it possible to activate a control mechanism. This roller accompanies the increase in apparent radius and is able to for example to instigate the uncoupling of the pulley system and the engagement of the steady state transmission system. In the already-mentioned example of the bicycle, the arm carrying this roller would allow the front pulley to be uncoupled from the pedal crank axis and the conventional chain wheel to be coupled thereto.

In one particular embodiment of the invention, the pitch curve of the winding of at least one pulley exhibits more or less rapid variations in apparent radius in order to act on the rate of variation of the reduction ratio. This may be dependent on the input torque where this torque is variable. The general shapes of the pitch curves of the pulleys remain spirals, but in which there are more or less rapid variations in radius dependent on the polar angle. These variations may also be desirable in order to satisfy the loads to be provided, such as compression points in a piston system, or in order to obtain regions with constant velocity ratio, for example in order to facilitate changes in couplings. These variations may be obtained at the desired points by varying the thickness of the flexible element or in cyclic locations using the geometry of the spirals or the shape of the hub. In the already-mentioned example of the bicycle, the front pulley could have a spiral that is non-uniform but in the shape of an ellipse, with the minor axis aligned with the crank arm in order to enjoy the longest lever arm when the torque available is the lowest.

Of course other embodiments can be envisioned without departing from the field of protection of the present invention.

### BRIEF DESCRIPTION OF THE DRAWING

Other particulars and features of the invention will become apparent from the detailed description of one advantageous embodiment given hereinbelow by way of illustration and with reference to the attached drawing (FIG. 1).

FIG. 1 depicts a straight-on view of a preferred variant of the present transmission system in an application to aiding the starting of a bicycle. The support structure which is the frame of the bicycle has not been depicted.

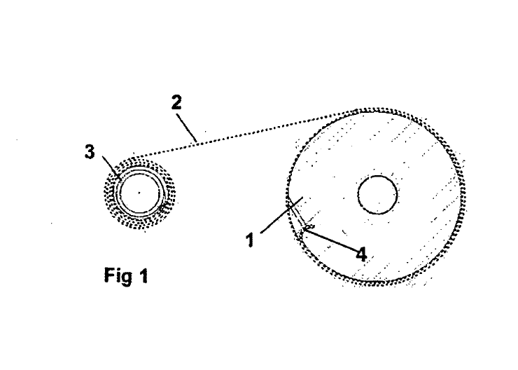

### DETAILED DESCRIPTION OF THE INVENTION

The driving pulley 1 rotates about the axis of the pedal crank mechanism and the driven pulley 3 about the axis of the rear wheel.

In the context of the application to the starting aid of a bicycle, the present system is normally used only in the phase of starting the bicycle. Thus, a coupling means intended either manually and/or automatically to select how the rear wheel of the bike is driven, namely either using the present transmission system or using the conventional transmission system employing a chain and rear sprocket(s) will advantageously also be provided. Whichever transmission is used, the driving force is applied to the driving pulley or to the front chain wheel, respectively, via the pedals.

In this variant, the pulleys 1 and 3 are preferably coplanar and the flexible element 2, which is a non-closed flat belt, is wound onto the pulley 1 while it is being unwound in the pulley 3, the two pulleys rotating in the clockwise direction. Because the pulleys are coplanar, the belt does not require any guidance and follows the path of the common tangent external to the two spirals formed by the turns of belt in situ on each of the pulleys. The ends of the belt are tied at the locations 4 provided in the hubs of each pulley and these attachments are strengthened through the capstan winding effect of the first turn of each winding.

The position depicted in the FIGURE is an intermediate position in the phase of operation which has begun with a starting position in which the driving pulley 1 has fewer turns of the belt and the driven pulley 3 has more of these, therefore with a step up ratio lower than the one depicted which is approximately 3. Movement continues with the driving pulley 1 continuing to wind the belt on with its apparent radius increasing while the driven pulley 3 unwinds the belt and experiences a decrease in its apparent radius. The step up ratio will therefore increase and the system will achieve a step up ratio close to that desired for normal operation and the pulley system will be uncoupled from the pedal crank mechanism and from the rear wheel. The conventional transmission system using the chain wheel, chain and rear sprocket, not depicted, which had been uncoupled will then take over the normal operation.

It will be noted that the curve formed by the belt, when considering a neutral axis, is a section of straight line extended on each side by portions of an Archimedean spiral, everything lying in the same plane. This idea of spirals, which are planar curves, should be differentiated in the idea of helixes which are non-planar, three-dimensional, curves.

1. A transmission system comprising a support structure and two pulleys, which pulleys are connected by a flexible element, possibly guided, wherein the flexible element is spiral-wound onto the driving pulley as it is being unwound from the driven pulley.

2. The system as claimed in claim 1, wherein the thickness of the flexible element is constant and wherein the hub of the pulleys is not cylindrical and exhibits an offset equal to this thickness.

3. The system as claimed in claim 1, wherein at least two identical flexible elements are used, these originating from at least two driven pulleys and being wound onto a single driving pulley or originating from one single driven pulley and being wound onto at least two driving pulleys.

4. The system as claimed in claim 1, wherein the pulleys are coaxial.

5. The system as claimed in claim 4, wherein at least two flexible elements are used.

6. The system as claimed in claim 4, wherein the pulleys do not form a complete disk and are coplanar.

7. The system as claimed in claim 4, wherein the support structure can rotate in just one direction about the common axis of the pulleys.

8. The system as claimed in claim 1, wherein a mechanism can rewind the flexible element onto the driven pulley.

9. The system as claimed in claim 1, wherein at least one pulley has a cylindrical hub and wherein the corresponding end of the flexible element has a thickness continuously tapering down to zero.

10. The system as claimed in claim 1, wherein the thickness of a working part of the flexible element varies.

11. The system as claimed in claim 1, wherein the outside diameter of at least one of the windings or a reference mark on the flexible element is used to control said system.

12. The system as claimed in claim 1, wherein the pitch curve of the winding of at least one pulley exhibits more or less rapid variations in the apparent radius.
